(19) United States
(12) Patent Application Publication
(10) Pub. No.: US 2017/0243410 A1
(43) Pub. Date: Aug. 24, 2017

(54) TRANSACTION MANAGEMENT METHOD BY RECOGNITION OF THE REGISTRATION NUMBER OF A VEHICLE

(71) Applicant: ONEY SERVICIOS FINANCIEROS EFC S.A.U., Madrid (ES)

(72) Inventor: Santiago CABALLERO, Madrid (ES)

(73) Assignee: ONEY SERVICIOS FINANCIEROS EFC S.A.U., Madrid (ES)

(21) Appl. No.: 15/501,467

(22) PCT Filed: Aug. 8, 2014
(86) PCT No.: PCT/EP2014/067132

§ 371 Date: Feb. 3, 2017

(51) Int. Cl. G07C 5/00; G06Q 20/10; G06Q 20/32; G06Q 20/40

(52) U.S. Cl. CPC G07C 5/008; G06Q 20/40; G06Q 20/102; G06Q 20/3224; G06Q 50/30

(57) ABSTRACT

Transaction management method based on the recognition of the registration of a vehicle (2), this method comprising:
a step of pre-storage, by a client (1), of personal identification, payment and identification data of at least one vehicle (2);
a step of reading of the registration of a vehicle (2);
a step of transmission of the registration of the vehicle (2) to a data platform (5);
a step of identification of the vehicle (2) by the data platform (5);
a step of authentication of the client (1) by the inputting of a personal identification number;
a step of proposal of a transaction to the authenticated client (1);
a step of pre-authorization of the transaction by the client (1);
a step of transaction authorization by a transaction authorization server (6);
a step of informing of the client (1) of the transaction authorization.

The invention deals with the field of the securing and the simplifying of payment methods offered to clients. More particularly, the invention deals with the payment methods available in places of sale likely to accommodate vehicles, such as service stations.

Place of sale should hereinbelow be understood to mean any place likely to offer a client a service or an object of sale, via the establishing of a transaction with the client.

Service stations constitute the most visible final destination of oil products offered to clients, individuals or professionals, by fuel distributors. As an example, service stations can be located by fuel distributors in proximity to trade locations (e.g. supermarkets, hypermarkets), these distributors sometimes themselves being in charge of said business enterprises. Moreover, the self-service dispensing of fuels with automatic payment by card has now been available to clients for many years. It is thus possible to directly pay for a transaction at a fuel pump when the latter is associated with an electronic payment terminal, via the use of a bank card or of a specific card offered by the fuel distributor to the client (exclusive card, also said private card). These payment methods generally require the physical insertion of the card of the client into a card reader of an electronic payment terminal. The procedure, conventional for the client, consists in inserting his or her card into the reader, waiting a few seconds for a connection to be set up between the electronic payment terminal and a remote authorization server, entering the personal code associated with the card and finally removing his or her card once the latter has been accepted and beginning to fill the tank of his or her vehicle. Thus, the correct completion of a transaction is conditional on various physical parameters such as the condition of the magnetic stripe of the card used (guaranteeing that it can be read), the physical condition of the card reader, or even the availability of the connection between the electronic payment terminal and the authorization server. Thus, a single malfunction such as an illegible magnetic stripe, a hardware or software fault on the reader, or an unavailable connection, prevents any transaction from being performed. Alternative automated payment solutions, simplified and friendly for the client, would therefore be particularly advantageous.

An object of various embodiments is to address the abovementioned drawbacks.

A first objective is to propose an automated payment method that is simplified for the clients.

A second objective is to propose an automated payment method that makes it possible to do away with the physical constraints of a card or of an electronic payment terminal arranged at a place of sale.

A third objective is to propose an automated payment method that offers enhanced security conditions in the transactions offered to the clients.

A fourth objective is to propose an automated payment method that enables the client to easily manage his or her preferred payment method(s).

A fifth objective is to propose an automated payment method adapted according to the vehicle of the client.

To this end, there is proposed, according to a first aspect, a transaction management method based on the recognition of the registration of a vehicle of a client, this method comprising the following steps:
a step of pre-storage, by the client in a data platform, via a first terminal, of personal identification data, payment data and identification data of at least one vehicle;
a step of reading of the registration of a vehicle of the client by detection and reading means deployed at a place of sale accommodating the vehicle;
a step of transmission of the registration of the vehicle read by the detection and reading means to the data platform;
a step of identification of the vehicle by the data platform, by comparing the read registration of the vehicle and the identification data of at least one pre-stored vehicle;
a step of authentication of the client by the inputting of a personal identification number specific to the client, in the first or in a second terminal, the terminal used for the authentication of the client being present at the place of sale;
a step of proposal of a transaction to the authenticated client, by the terminal used for the authentication of the client, the proposed transaction being dependent on the information concerning the data pre-stored by the client and the identified vehicle;
a step of pre-authorization by the client of the proposed transaction;
a step of sending, to a transaction authorization server, of an authorization request by the data platform for the transaction pre-authorized by the client;
a step of transaction authorization by the transaction authorization server, via the transmission of a response to the data platform;
a step of transmission of the transaction authorization by the data platform to the terminal used for the authentication of the client;
a step of informing the client of the transaction authorization, by the terminal used for the authentication of the client.

Advantageously, in this method, the data platform proposes to the client a vehicle fleet management service, this service being performed by
the inputting by the client, in the first terminal, of a set of information relating to a plurality of vehicles, this information comprising, for each vehicle, a registration, the make and the model of the vehicle, the type of fuel consumed, a limit consumption budget for one or more vehicles over a configurable period, and the association of each vehicle with one or more pre-stored clients;
a calculation by the data platform of the consumption budget remaining for each vehicle or each client, as a function of the transactions performed by each client;
the informing of the client of the transactions and of the budget remaining for each vehicle, via an appropriate display on the first terminal or a message pushed to the terminal used for the authentication of the client.

Advantageously, in this method, the terminal used for the authentication of the client is a mobile terminal comprising a mobile application, the mobile application being suitable for proposing to the client the updating of the data that he or she has pre-stored, the inputting of his or her personal identification number, the display, the pre-authorization, the status, the consultation, the storage of the transaction history and the location of at least one place of sale closest to the location of the mobile terminal.

Advantageously, in this method, the data platform comprises
a client management module suitable
   for proposing, to any terminal, an appropriate graphical interface for the pre-storing and/or the updating of data by the client in a database;
   for proposing the addition and the validation of a bank payment card in the graphical interface, the validation of the bank payment card being performed by a transaction;
a transaction management module suitable
   for supplying, to any terminal present at the place of sale, a graphical interface suitable for authenticating the client, displaying the transaction proposal, enabling the client to pre-authorize this transaction, and informing the client of the progress of the transaction;
   for sending, to the transaction authorization server, an authorization request for the transaction pre-authorized by the client and receiving the response from the transaction authorization server.

Advantageously, in this method,
the identification of an exclusive card added by the client in the graphical interface of the client management module is communicated to an exclusive card authentication server interfaced with the client management module and the transaction management module;
a transaction via an exclusive card is performed by the sending of a transaction request from the transaction management module to an exclusive card transaction authorization server, followed by a response from the exclusive card transaction authorization server to the transaction management module.

There is proposed, according to a second aspect, an automated payment system based on the recognition of the registration of a vehicle of a client, this system comprising
a first terminal suitable for pre-storing, in a data platform, personal identification data, payment data and identification data of at least one vehicle input by the client in the terminal;
detection and reading means suitable
   for reading the registration of a vehicle of the client, the detection and reading means being deployed at a place of sale accommodating the vehicle;
   for transmitting the registration of the vehicle read to the data platform;
the data platform being suitable for
   identifying the vehicle, by comparing the read registration of the vehicle and the identification data of at least one pre-stored vehicle;
   authenticating the client by comparing a personal identification number transmitted by the first or a second terminal, the terminal used for the authentication of the client being present at the place of sale;
the terminal used for the authentication of the client being suitable for proposing to the client
   the inputting of the personal identification number specific to the client;
   a transaction that is dependent on the information concerning the data pre-stored by the client and the identified vehicle;
   a pre-authorization of the proposed transaction;
the data platform also being suitable for sending, to a transaction authorization server, an authorization request for the transaction pre-authorized by the client;
the transaction authorization server being suitable for authorizing the transaction by the transmission of a response to the data platform;
the terminal used for the authentication of the client also being suitable for receiving the transaction authorization transmitted by the data platform and informing the client of the transaction authorization.

Advantageously, in this system, the data platform is suitable for proposing, to the client, a vehicle fleet management service, this service being performed by
the inputting by the client in the first terminal of a set of information relating to a plurality of vehicles, this information comprising, for each vehicle, a registration, the make and the model of the vehicle, the type of fuel consumed, a limit consumption budget for one or more vehicles over a configurable period, and the association of each vehicle with one or more pre-stored clients;
a calculation, by the data platform, of the consumption budget remaining for each vehicle or each client, as a function of the transactions performed by each client;
the informing of the client of the transactions and of the budget remaining for each vehicle via an appropriate display on the first terminal or a message pushed to the terminal used for the authentication of the client.

Advantageously, in this system, the terminal used for the authentication of the client is a mobile terminal comprising a mobile application, the mobile application being suitable for proposing, to the client, the updating of the data that he or she has pre-stored, the inputting of his or her personal identification number, the display, the pre-authorization, the status, the consultation, the storage of the transaction history and the location of at least one place of sale closest to the location of the mobile terminal.

Advantageously, in this system, the data platform comprises
a client management module suitable for
   proposing, to any terminal, an appropriate graphical interface for the inputting and the storing of data by the client in a database;
   proposing the addition of a bank payment card in the graphical interface, the validation of a bank payment card being performed by a transaction proposed to the client and performed via exchanges between the client management module and the transaction authorization server;
a transaction management module suitable
   for proposing, to any terminal used for the authentication of the client, an appropriate graphical interface for the display, the modification, and the pre-authorization of the transaction proposed to the client;
   for communicating with the transaction authorization server, via the sending of an authorization request for the transaction pre-authorized by the client.

Advantageously, this system also comprises
an exclusive card authentication server interfaced with the client management module and the transaction management module, suitable for receiving the identification of an exclusive card added by the client in the graphical interface of the client management module;
an exclusive card transaction authorization server suitable for receiving a transaction request from the transaction management module for an exclusive card and sending a response concerning the request to the transaction management module.

Other objects and advantages of various embodiments will become apparent in light of the description, given hereinbelow with reference to the attached drawings in which:

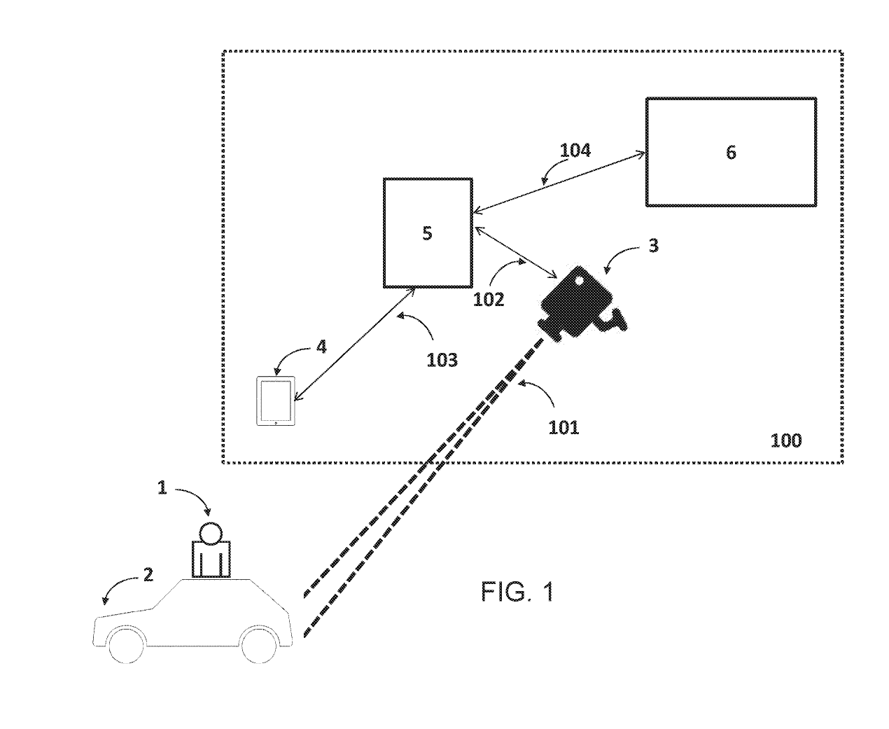

FIG. 1 is a representation of the automated payment system according to an embodiment;

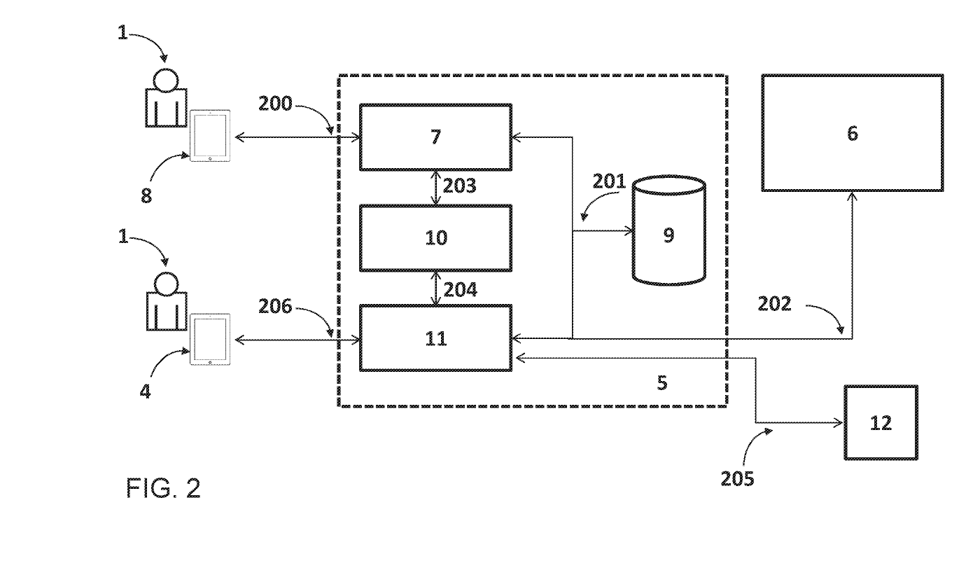

FIG. 2 is a representation of a part of the automated payment system according to an embodiment;

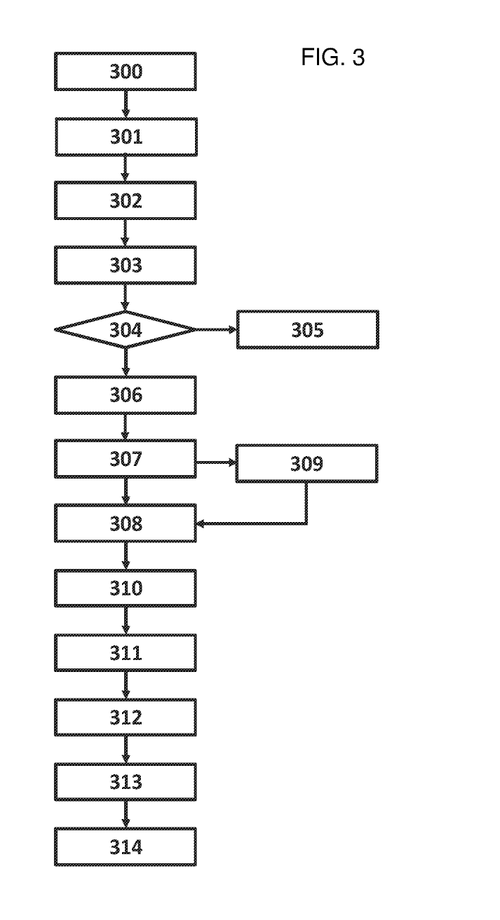

FIG. 3 is a figure illustrating the steps of an automated payment method according to an embodiment.

FIG. 1 shows an automated payment system 100 that can be offered to a client 1 at a determined place of sale involving the presence of at least one vehicle 2. As an example, the determined place described hereinafter in this document is a service station. However, any other place likely to accommodate vehicles 2, to offer a client 1 a service or an object of sale and accommodate such a system 100 can be envisaged (for example: toll, parking area, car park). Advantageously, the system 100 is compatible with any registered vehicle 2 and comprises the following elements:
detection and reading means 3, suitable for capturing and identifying the alphanumeric characters of a registration plate of the vehicle 2. These means 3 are, for example, produced by a system comprising
   one or more cameras (or any other device for capturing images) arranged in proximity to a fuel pump of the service station, making it possible to capture the images of the registration plates at the front and/or rear of a vehicle 2;
   a method implemented in firmware making it possible to determine the registration of the vehicle 2 from one or more captured images;
a terminal 4 present in proximity to the place of sale, here a fuel pump of the service station, this terminal 4 being suitable for offering means to the client 1 to perform the transaction. As an example, the terminal 4 is
   an electronic payment terminal comprising a touch screen, provided with an Internet connection, fixedly positioned in proximity to the petrol pump and offering the client 1 a transaction selection and management interface. Such an interface is, for example, produced by a touch human/machine interface (HMI);
   any mobile terminal in the possession of the client 1, this terminal comprising means for communicating data via a wireless network, for example a tablet or a smart phone provided with a WiFi, Bluetooth, 2G, 3G or 4G data link;
a server, a set of servers or, more generally, a data platform 5 (described later), comprising in particular data relating to the client 1 and to his or her vehicle 2, the data platform 5 being suitable for exchanging data via a pre-established connection with the terminal 4;
a transaction authorization server 6, making it possible to authorize or deny a transaction, as a function, for example, of the bank balance of a client 1 or of his or her presence in a list of authorized or barred clients 1.

The operation of the system 100 is now described in a simplified manner and will be detailed more hereinbelow. In one embodiment, the automated payment system 100 allows a transaction to take place, from its initiation to its validation (or its prohibition), as follows:
a client 1 provided with his or her vehicle 2 arrives at a place of sale, here a service station provided with at least one petrol pump;
means 3 for detecting and reading alphanumeric characters, deployed at the place of sale, for example one or more cameras, “read” (dotted lines 101) the registration plate of the vehicle 2 and then transmit (arrow 102), to the data platform 5, the registration information of the identified vehicle 2;
the data platform 5 then performs a step of comparison between the registration of the vehicle 2 and vehicle information pre-stored in the data platform 5, in order to identify the vehicle 2 corresponding to this registration as well as the client(s) 1 using this vehicle 2;
the data platform 5 then transmits (arrow 103), in return to the terminal 4, as a function of the identified vehicle 2, a request to identify the client 1;
the terminal 4 then prompts the client 1 to input a previously known personal password or personal identification number (“PIN” code), that it then returns to the data platform 5 for verification;
if the identification relating to the client 1 is effective (e.g.: PIN code correct), the data platform 5 then transmits, to the terminal 4, preconfigured transaction information relating to the client 1, for example a theoretical and preconfigured transaction value dependent on the client 1 and his or her vehicle 2;
the terminal 4 then proposes (arrow 103), to the client 1, a transaction via an appropriate display, the displayed transaction being a function of the information transmitted by the data platform 5;
if the proposed transaction is suitable to the client 1, the latter validates it via a selection menu displayed on the terminal 4. The client 1 can also, if necessary, modify some of the parameters of the transaction via a selection menu, then validate the latter or even cancel it;
after a transaction is validated by the client 1, the terminal 4 then transmits (arrow 103) the selected transaction to the data platform 5;
the data platform 5 then interrogates (arrow 104) the transaction authorization server 6 in order to authorize or not authorize the transaction;
depending on the response from the transaction authorization server 6 (arrow 104), the client 1 is then informed by the terminal 4 (arrow 103) if he or she is or is not authorized to perform an action relating to the transaction; for example, the client 1 is informed by the terminal 4 that he or she can use an authorized and unlocked petrol pump, in order to fill the tank of his or her vehicle 2 with fuel;
when the client 1 has finished the action relating to the transaction, here filling the tank of his or her vehicle 2 with fuel, the point of sale, here the fuel pump, then transmits, to the data platform 5, the real amount of the transaction. This amount can, as an example, slightly differ from the theoretical amount of the proposed transaction, because of the accuracy with which fuel is dispensed by the fuel pump;
the data platform 5 then retransmits (arrow 104) the real amount of the transaction to the transaction authorization server 6 for the client 1 to be billed.

Various more detailed embodiments are now described with reference to FIG. 2.

In one embodiment, the automated payment system 100 equally allows for the acceptance of specific payment cards offered by a predetermined vendor (exclusive cards), for example a fuel distributor, and any bank payment card. For this, the data platform 5 comprises a client management module 7, enabling the client 1 to supply information concerning his or her payment means and his/their vehicle(s) 2. Advantageously, the client management module 7 provides a graphical interface enabling the client 1 to supply this information. Such a graphical interface can, for example, be accessible from a predefined Internet address, and allow exchanges of data (arrow 200) according to the secure hypertext transfer protocol (HTTPS), between any terminal 8 having a network connection and the client management module 7. The terminal 8 can, by way of example, be a computer, a smartphone, or a tablet, or even the terminal 4 arranged in proximity to the place of sale.

Thus, for a first use, the graphical interface of the client management module 7 offers any client 1 the possibility of creating a user account. In creating an account, a client 1 is notably prompted to input the following information:
personal information
   his or her identity (name, first name for an individual, name of the company for a professional client);
   his or her details (email, telephone number);
   his or her tax number;
   the numbers of one or more payment cards (specific card of a vendor and/or bank card);
   choice of an identification code specific to the user, for example a personal identification number PIN;
information relating to his or her/their vehicle(s) 2
   the registration number of each vehicle 2 that he or she wants to use with the payment service offered by the automated payment system 100;
   the make and the model of each of these vehicles 2;
   the type of fuel used by each of these vehicles 2;
   the quantity of fuel offered by default by the petrol pump for each vehicle 2, for example, the choice of a desired fixed price associated with the type of fuel or the choice of a desired fixed volume of fuel;
the choice of the desired payment mode, for example an immediate or deferred debit, or monthly payments;
the selection of a default preferential payment means, via the selection of a card number pre-stored previously by the client 1.

According to various embodiments, all the information input by the client 1 in the graphical interface of the client management module 7 is stored in a database 9 that is a component of, or externally interfaced with, this module. Thus, the client management module 7 is suitable for both completing/retrieving (arrow 201) any datum supplied by the client/pre-stored in the database 9.

In particular, in subsequent uses of the graphical interface of the client management module 7 by the client 1, the information supplied to the database 9 can subsequently be modified or added to by the client 1. To do this, the client 1 first identifies him or herself via a specific identification code, for example via his or her personal identification number PIN which he or she will have chosen previously, as well as information relating to his or her identity (e.g.: email, or user name).

Advantageously, any individual or professional (e.g.: company) client 1, having a plurality of vehicles 2, can then use the graphical interface of the client management module 7, as a vehicle 2 fleet management service. For example, in the context of the management of a fleet of vehicles 2 of a company, an administrator using this interface can register a determined number of employees and assign them a specific vehicle 2. For such a service, the graphical interface of the client management module 7 also makes it possible to configure expenditure thresholds.

Advantageously, the expenditure thresholds defined by a user apply for a time period that can be configured via the graphical interface. For this, the graphical interface of the client management module 7 proposes choosing a periodical ‘top-up’ date (or several such dates, e.g.: every 5th and/or 20th of the month), making it possible to reinitialize, after said elapsed period, the balance of expenditure remaining authorized relative to the preconfigured maximum threshold. Thus, in one embodiment, the interface of the client management module 7 proposes, to a client 1, after selecting a payment card, setting a maximum expenditure threshold, for example an expenditure threshold specific to a vehicle 2, and/or a “global” expenditure threshold, that is to say one shared with a set of vehicles 2. In another embodiment, in order to ensure the management of several users by an administrator, the interface of the client management module 7 proposes, to the administrator, setting a maximum expenditure threshold for each user for a configurable period.

Thus, in the preceding embodiments, the client management module 7 is suitable for calculating the balance remaining relative to the preconfigured maximum expenditure threshold, communicating it to the client 1 via the graphical interface, and optionally sending pushed notifications (e.g.: by SMS text messages or email to a mobile terminal 4) to the client 1 if the balance remaining is situated below an alert threshold, that can also be preconfigured by the user by means of the graphical interface of the client management module 7. In the example of a company, each employee will be able to have communicated, by the administrator, an identifier (e.g.: email, encrypted identification sequence) and a default specific password/code, for example a personal identification number PIN, enabling him or her to access the vehicle 2 fleet management interface. Access to this interface is then made for the employee as a simple user (limitation on the configurable parameters), enabling him or her to optionally reconfigure his or her personal identification number PIN, choose an available car from the fleet of vehicles 2 of the company, consult his or her consumption, in particular his or her remaining balance, or even consult a pre-stored history of the transactions that he or she has previously performed. Advantageously, the configurable personal identification number for each user of a same vehicle 2 is unique. This makes it possible in particular to discriminate the transactions for clients 1 sharing a same vehicle 2 in turn.

Advantageously, the vehicle fleet 2 management proposed by the graphical interface of the client management module 7 also enables a supplier of a client company, for example an oil company supplying fuel to hypermarket chains, to check that each of its client companies is offering payment guarantees. For this, the client management module 7 can offer a graphical interface that is separate from the graphical interface offered to the clients 1, and that can be accessed from an Internet address that is distinct from the address of the graphical interface offered to the clients 1. Such an interface makes it possible, for example, for a supplier to add as many client companies as necessary, by inputting, in the graphical interface, for each client company, a name, a unique identifier ID, and the tax number of the company. After this addition, it is then possible for it to supervise the data supplied by the client companies, for example
the preconfigured maximum expenditure thresholds, defining the financial guarantee of each client company;
the available current balance of the client company for said proposed service;
the periodic date of reinitialization of the balance of the client company;
the history of the transactions of the client company;
the vehicles 2 and users declared by the client company in order to benefit from said service.

In one embodiment, a bank payment card is stored for a client 1 as follows:
a client 1 performs a preliminary step of connection to the graphical interface of the client management module 7;
in creating a new account, or in updating his or her personal information, the client 1 selects, in the interface, a payment card management menu, produced for example via the implementation in the graphical interface of an “add payment cards” button;
the client management module 7 then asks the user to enter his or her card number, called PAN (Primary Account Number), the date of expiry of his or her card, and his or her visual cryptogram, for example the card verification code, called CVV2 (acronym for “Card Code Verification Value”);
all of these data are then transmitted encrypted via an algorithm to a transaction authorization server 6, suitable for decrypting, via the same algorithm, this information and validating or not validating transactions for this card. As an example, the validation of a transaction by the server 6 depends notably on a list of authorized cards, on the balance of the bank card of the client 1, and on the status of the information (correct or incorrect) input by the client 1 and transmitted by the client management module 7;
advantageously, in order to validate the added card, the transaction authorization server 6 proposes a first transaction to the client 1, via the taking of charges from the account of the client 1. The transaction authorization server 6 then transmits a challenge in accordance with the 3D-Secure protocol to the client management module 7, the latter offering it to the client 1 via the graphical interface. The client then validates the proposed transaction by inputting, in the graphical interface, the correct response to this challenge, this response being retransmitted from the client management module 7 to the transaction authorization server 6;
if the response to the challenge that is returned is correct, the transaction authorization server 6 validates the transaction and authorizes the bank card. Once the bank card is validated, the server 6 then generates an identification token that is unique and specific to the added bank card, then returns this authentication token to the client management module 7;
the information relating to the added card and the corresponding generated authentication token is then stored encrypted by the client management module 7 in a table of the database 9.

Advantageously, such a method makes it possible, upon subsequent transaction requests to the transaction authorization server 6, after prior identification of the client 1 and validation of one of his or her payment cards, to communicate only the authentication token corresponding to this card in exchanges between the client management module 7 and the transaction authorization server 6, and do so without transmitting sensitive information (e.g.: PAN, CVC) linked to the bank card of the client 1. Such a mechanism therefore reinforces the security of the transactions. It is understood that any communication between the client management module 7 and the transaction authorization server 6 is also secured. Thus, between the client management module 7 and the transaction authorization server 6, a communication mechanism is used (arrow 202) that is in accordance with the PCI/DSS (Payment Card Industry Data Security Standard) standards. As an example, for the exchanges of data between the client management module 7 and the transaction authorization server 6, an end-to-end encryption is used, called P2PE (acronym for “Point-to-Point Encryption”).

Furthermore, if it is necessary to separate management (for example the addition and the authentication) of bank cards from exclusive cards, that is to say from cards distributed by and specific to a vendor, the latter can, in one embodiment, be supervised by an exclusive card authentication server 10. Advantageously, the exclusive card authentication server 10 is then suitable for managing only this type of card, and is for example produced via an existing proprietary server solution, interfaced with the client management module 7. Thus, according to various embodiments, for any use of an exclusive card, for example during a first registration of the card or during a transaction request via this card, the client management module 7 and the exclusive card authentication server 10 exchange (arrow 203) a set of data dependent on the proprietary solution deployed. As an example, during the first registration by a client 1 of an exclusive card, the client management module 7 communicates, to the exclusive card authentication server 10, one or more encrypted information items relating to the exclusive card input by the client 1, for example the card number, and information concerning the identity of the client 1. This information is also stored in the database 9, the latter being accessible to the exclusive card authentication server 10 (arrow 201).

Advantageously, the communication of data between the client management module 7 and the exclusive card authentication server 10 is performed via the secured hypertext transfer protocol HTTPS combined with the advanced encryption standard (encryption algorithm) AES.

The data platform 5 also comprises a transaction management module 11 interfaced with the exclusive card authentication server 10. Advantageously, the transaction management module 11 and the exclusive card authentication server 10 are suitable for setting up a communication (arrow 204) allowing for the exchange of data, via the secured hypertext transfer protocol HTTPS combined with the advanced encryption standard (encryption algorithm) AES. Furthermore, the transaction management module 11 is suitable for exchanging data with
the client management module 7 and the database 9 of the data platform 5 (arrow 201);
any terminal 4 present in proximity to the place of sale;
in accordance with the PCI/DSS standards, for example by using the end-to-end encryption P2PE (arrow 202);
an exclusive card transaction authorization server 12 (arrow 205). Just like the exclusive card authentication server 10, the exclusive card transaction authorization server 12 is deployed if needed to manage the transactions with the exclusive cards. Such a server can also be produced via a proprietary solution. Advantageously, the transaction management module 11 then communicates with the exclusive card transaction authorization server 12 via the data transport protocol MPLS (an acronym standing for “MultiProtocol Label Switching”. Thus, in one embodiment, the exclusive card transaction authorization server 12 is responsible for managing only the transactions performed with exclusive cards, whereas the transaction authorization server 6 is responsible for managing the transactions performed via bank cards.

The transaction management module 11 also comprises an interface making it possible to exchange data (arrow 206) with the detection and reading means 3, suitable for capturing and identifying the alphanumeric characters of the registration plate of the vehicle 2. A transaction according to the proposed automated payment system 100 in fact requires the identification of the vehicle 2 and therefore the transmission of the registration of the vehicle 2 to the data platform 5. In order to guarantee the integrity of the data exchanged, the communication of the data between the transaction management module 11 and the detection and reading means 3 is, for example, performed via the secured hypertext transfer protocol HTTPS combined with the advanced encryption standard (encryption algorithm) AES.

Advantageously, the transaction management module 11 offers a client 1 a graphical interface, enabling him or her to participate in a transaction, by displaying selectable preconfigured transaction information (e.g.: proposed quantity of fuel, proposed transaction price), this information being able to be modified by the client 1. In order for the client 1 to be able to interact with the transaction management module 11, the graphical interface of this module can be accessed from a predefined Internet address, and allows exchanges of data (arrow 206) according to the secured hypertext transfer protocol HTTPS from any terminal 4 present in proximity to the place of sale. Such a graphical interface is therefore equally accessible via a touch screen deployed by the distributor at the place of sale, and from a smart phone in the possession of the client 1 present at the place of sale.

Moreover, the graphical interface associated with the client management module 7 described previously can be produced in different forms. According to various embodiments, the graphical interface takes the form of a web site accessible from any terminal provided with an Internet connection, and/or is also produced in the form of a mobile application offered to mobile terminals such as smartphones or tablets.

Thus, a client 1 provided with a smartphone can choose to create an account via the mobile application or an Internet site. The use of the mobile application, after authentication, then enables him or her subsequently to update the information that he or she has supplied (e.g.: personal data, vehicle data, payment means) and take part in the transactions at a place of sale, via a graphical interface specific to the mobile application. Advantageously, such a mobile application offers the client 1 at least the same services as those offered by the graphical interfaces of the client management module 7 and the transaction management module 11. Other services can moreover be offered to the client 1 by this application, for example the option of
consulting a personal transaction history;
exploiting geolocation means embedded in the user mobile terminal, to propose at least one place of sale, here a service station, identified as closest relative to the location of the terminal;
receive, by a so-called “push” method, for example via SMS or email, a message comprising the information relating to each transaction performed by the client 1;
receive personalized advertising information;
be able to manage a set of electronic coupons, promotional offers, and/or loyalty programs, thus adding a play element to the client experience.

FIG. 3 illustrates, in accordance with the elements previously described, various steps relating to a transaction conducted between a client 1 and the automated payment system 100.
the step (300) relates to a step of pre-storage of the client 1. A client 1 provided with a vehicle 2, and wanting to benefit from an auto-payment service based on vehicle 2 registration recognition, provides the client management module 7 with information relating to his or her identity, his or her vehicle 2, his or her preferred consumption methods, and the desired transaction mode, and chooses a PIN code. This pre-storage step is performed by the client 1 by logging on to a pre-established Internet site via a terminal 8 or by using a mobile application previously downloaded and installed on a mobile terminal in his or her possession. Advantageously, the Internet site and the mobile application offer the client 1 an appropriate graphical interface for inputting this information;
in the step (301) the client 1 arrives with his or her vehicle 2 at a place of sale, for example a service station. Advantageously, the place of sale comprises a terminal 4 which can be a fixed terminal arranged by the vendor at the place of sale, or a mobile terminal in the possession of the client 1. In order to perform a transaction, the terminal 4 comprises a secure connection with the transaction management module 11, the latter managing a graphical interface displayed on the terminal 4. Such a connection can be preconfigured in the case of a fixed terminal, or set up by the user for a mobile terminal via the opening of the mobile application. Optionally, the client 1 has the option of selecting, by choice via the graphical interface of the terminal 4 (managed by the transaction management module 11), either a “conventional” payment method (physical reading of a card in his or her possession), or the proposed automated payment method, described in the following steps;
in the latter case, detection and reading means 3, such as cameras arranged in the vicinity of the place of sale, capture and recognize (“read”) the vehicle 2 registration data (step 302);
once recognized, the vehicle 2 registration data are communicated in a message by the detection and reading means 3 to the transaction management module 11 (step 303). The detection and reading means 3 also add, for the purposes of identification in the transmitted message, the date and the time of reading of the vehicle 2 registration, as well as the number of the fuel pump where the vehicle 2 is situated;
in the step (304) the transaction management module 11 seeks to identify, via a step of comparison with the data pre-stored in the database 9, the identity of the vehicle 2 and of its user. If the vehicle 2 is not in the database 9, this means that the user has not pre-stored the data relating to this vehicle 2. The transaction management module 11 then transmits an error message to be displayed on the terminal 4 and/or a message prompting the client 1 to perform the pre-storage step (300) if he or she wants to use the proposed auto payment service (step 305);
if the vehicle 2 is identified by the client management module 7 in the database 9, the client 1 is then prompted to input, via the terminal 4, an identification code, for example a PIN code (step 306) that he or she has pre-stored in the database 9;
if the identification code input by the client 1 is valid, the terminal 4 then displays a transaction proposition (step 307), as a function of the data supplied by the client 1 in the pre-storage step (300). The proposed transaction is, for example, a given quantity of fuel for a predefined price, the latter also being able to be a function of expenditure thresholds that the client 1 will have preconfigured;
the client 1 then has the option, via the graphical interface of the terminal 4, either to validate the transaction (step 308) directly, or modify it (step 309) before validating it, if he or she wants, for example, to perform a transaction with a lower price. The step of validation (308) of the transaction by the client 1 can optionally be seen as a pre-authorization step, the transaction authorization server 6 then being solely responsible for the final authorization;
the transaction amount validated by the client 1 on the terminal 4 is transmitted to the transaction management module 11, which then checks whether such a transaction is possible. For this, the transaction management module 11 interrogates (step 310), via a transaction request, the transaction authorization server 6, as to the possibility of such a bank transaction;
if such a transaction is authorized, the transaction authorization server 6 notifies the transaction management module 11 thereof. The transaction management module 11 then jointly sends (step 311)
   an authorization message to an entity, provided with means of communication with the transaction management module 11, present at the place of sale and enabling the client 1 to access the transaction object. For example, the transaction management module 11 sends a control message to fuel dispensing pump locking device, making it possible to automatically unlock the fuel pump specified in the transaction;
   a message to the terminal 4 informing the client 1 that he or she can now access the object of his or her transaction, for example a message informing him or her that the corresponding pump is unlocked and that he or she can now fill the tank of his or her vehicle 2;
when the client 1 has finished accessing the object of the transaction, for example finished filling his or her fuel tank, the point of sale, here the petrol pump, informs the transaction management module 11 and sends it the real quantity of fuel dispensed and the final amount of the transaction. The transaction management module 11 then transmits the final amount of the transaction to the transaction authorization server 6 to debit the client 1 (step 312);
the details of the transaction are then stored by the transaction management module 11 in the database 9 (step 313). The terminal 4 then displays the details of the transaction for the client 1 (step 314). The details of this transaction can be for example displayed on a fixed screen deployed by the vendor at the end of the transaction, printed by selecting a menu on the fixed terminal, pushed by SMS or email to the mobile terminal of the client 1, or else displayed by the mobile application on the mobile terminal of the client 1, which can moreover access, download and/or store the history of the transactions performed by the client 1.

In one embodiment, the transactions performed for exclusive cards follow the same steps as those previously described, except that the exchanges performed between the transaction management module 11 and the transaction authorization server 6 are replaced by exchanges between the transaction management module 11 and an exclusive card transaction authorization server 12.

Advantageously, the embodiments described previously make it possible to offer a payment solution based on the automatic recognition of vehicle plates 2, and apply equally to the payment for fuel in service stations and in any other place likely to offer an automated payment solution for vehicles, for example a road toll area, a parking area or a car park.

Another advantage is the simplicity of the payment method offered to the client 1, enabling him or her thus to perform transactions much more rapidly than with the existing methods, such as those involving a physical use of a payment card.

The embodiments proposed also make it possible for each client 1 to manage his or her own electronic portfolio, via the addition and the use of one or more payment cards, that can also be exclusive cards distributed by a specific vendor (e.g.: hypermarket) and bank credit cards. The incorporation of new cards in no way affects the user experience.

Advantageously, the possibility for a client 1 to use a mobile terminal with the automated payment system 100 previously described also makes it possible
for the client 1 to interact with the data platform 5 without necessarily needing to use a terminal deployed by a vendor at a place of sale;
for any vendor to make financial savings, by avoiding having to necessarily deploy new interactive terminals 4 at their points of sale;
to reinforce the level of security of the service offered for each user. A terminal 4 is then specific to each client 1 and no longer shared between a number of clients 1, thus greatly limiting the potential impact on a set of clients 1 should a terminal 4 be spoofed. Furthermore, the identification of a client 1 results in both the recognition of the registration of his or her vehicle 2 combined with the input by the client of a password or PIN code. A transaction can therefore be performed only after a pre-authorization by the client 1, requiring a preliminary step of authentication of said client 1;
for the client 1 to personally manage (e.g.: consult, modify, delete) his or her own identifiers and data from a single mobile application;
for the client 1 to receive pushed notifications, for example a summary of a finalized transaction by SMS, or targeted advertising, and manage personal discount coupons.

Another advantage of the automated payment system 100 described previously is the implementation of a service making it possible to manage information relating to a fleet of vehicles 2. Such a service can, by way of examples, equally be offered to a vendor supplying its services to a plurality of client companies (e.g.: fuel dispensing), a company in order to manage the fleet of the vehicles 2 made available to its employees, or an individual/a professional having a plurality of vehicles for which he or she wants to manage the consumption mode.

1. A transaction management method based on the recognition of the registration of a vehicle of a client, this method comprising the following steps:
a step of pre-storage, by the client in a data platform, via a first terminal, of personal identification data, payment data and identification data of at least one vehicle;
a step of reading of the registration of a vehicle of the client by detection and reading means deployed at a place of sale accommodating the vehicle;
a step of transmission of the registration of the vehicle read by the detection and reading means to the data platform;
a step of identification of the vehicle by the data platform, by comparing the read registration of the vehicle and the identification data of at least one pre-stored vehicle;
a step of authentication of the client by the inputting of a personal identification number specific to the client, in the first or in a second terminal, the terminal, used for the authentication of the client being present at the place of sale;
a step of proposal of a transaction to the authenticated client, by the terminal, used for the authentication of the client, the proposed transaction being dependent on the information concerning the data pre-stored by the client and the identified vehicle;
a step of pre-authorization by the client of the proposed transaction;
a step of sending, to a transaction authorization server, of an authorization request by the data platform for the transaction pre-authorized by the client;
a step of transaction authorization by the transaction authorization server, via the transmission of a response to the data platform;
a step of transmission of the transaction authorization by the data platform to the terminal, used for the authentication of the client;
a step of informing the client of the transaction authorization, by the terminal, used for the authentication of the client.

2. The method according to claim 1, wherein the data platform proposes to the client a vehicle fleet management service, this service being performed by:
the inputting by the client, in the first terminal, of a set of information relating to a plurality of vehicles, this information comprising, for each vehicle, a registration, the make and the model of the vehicle, the type of fuel consumed, a limit consumption budget for one or more vehicles over a configurable period, and the association of each vehicle with one or more pre-stored clients;
a calculation by the data platform of the consumption budget remaining for each vehicle or each client, as a function of the transactions performed by each client;
the informing of the client of the transactions and of the budget remaining for each vehicle, via an appropriate display on the first terminal, or a message pushed to the terminal, used for the authentication of the client.

3. The method according to claim 1, wherein the terminal, used for the authentication of the client is a mobile terminal comprising a mobile application, the mobile application being suitable for proposing to the client the updating of the data that he or she has pre-stored, the inputting of his or her personal identification number, the display, the pre-authorization, the status, the consultation, the storing of the transaction history and the location of at least one place of sale closest to the location of the mobile terminal.

4. The method according to claim 1, wherein the data platform comprises:
a client management module suitable for:
proposing, to any terminal, an appropriate graphical interface for the pre-storing and/or the updating of data by the client in a database;
proposing the addition and the validation of a bank payment card in the graphical interface, the validation of the bank payment card being performed by a transaction;
a transaction management module suitable
for supplying, to any terminal, present at the place of sale, a graphical interface suitable for authenticating the client, displaying the transaction proposal, enabling the client to pre-authorize this transaction, and informing the client of the progress of the transaction;
for sending to the transaction authorization server, an authorization request for the transaction pre-authorized by the client and receiving the response from the transaction authorization server.

5. The method according to claim 4, wherein:
the identification of an exclusive card added by the client in the graphical interface of the client management module is communicated to an exclusive card authentication server interfaced with the client management module and the transaction management module;
a transaction via an exclusive card is performed by the sending of a transaction request from the transaction management module to an exclusive card transaction authorization server, followed by a response from the exclusive card transaction authorization server to the transaction management module.

6. An automated payment system based on the recognition of the registration of a vehicle of a client, this system comprising
a first terminal, suitable for pre-storing, in a data platform, personal identification data, payment data and identification data of at least one vehicle input by the client in the terminal,
detection and reading means suitable
for reading the registration of a vehicle of the client, the detection and reading means being deployed at a place of sale accommodating the vehicle;
for transmitting the registration of the vehicle read to the data platform;
the data platform being suitable for
identifying the vehicle, by comparing the read registration of the vehicle and the identification data of at least one pre-stored vehicle;
authenticating the client by comparing a personal identification number transmitted by the first or a second terminal, the terminal, used for the authentication of the client being present at the place of sale;
the terminal, used for the authentication of the client being suitable for proposing to the client
the inputting of the personal identification number specific to the client;
a transaction that is dependent on the information concerning the data pre-stored by the client and the identified vehicle;
a pre-authorization of the proposed transaction;
the data platform also being suitable for sending, to a transaction authorization server, an authorization request for the transaction pre-authorized by the client;
the transaction authorization server being suitable for authorizing the transaction by the transmission of a response to the data platform;
the terminal, used for the authentication of the client also being suitable for receiving the transaction authorization transmitted by the data platform and informing the client of the transaction authorization.

7. The system according to claim 6, wherein the data platform is suitable for proposing, to the client, a vehicle fleet management service, this service being performed by
the inputting by the client in the first terminal, of a set of information relating to a plurality of vehicles, this information comprising, for each vehicle, a registration, the make and the model of the vehicle, the type of fuel consumed, a limit consumption budget for one or more vehicles over a configurable period, and the association of each vehicle with one or more pre-stored clients;
a calculation, by the data platform, of the consumption budget remaining for each vehicle or each client, as a function of the transactions performed by each client;
the informing of the client of the transactions and of the budget remaining for each vehicle via an appropriate display on the first terminal, or a message pushed to the terminal, used for the authentication of the client.

8. The system according to claim 6, wherein the terminal, used for the authentication of the client is a mobile terminal comprising a mobile application, the mobile application being suitable for proposing, to the client, the updating of the data that he or she has pre-stored, the inputting of his or her personal identification number, the display, the pre-authorization, the status, the consultation, the storage of the transaction history and the location of at least one place of sale closest to the location of the mobile terminal.

9. The system according to claim 6, wherein the data platform comprises:
a client management module suitable for:
proposing, to any terminal, an appropriate graphical interface for the inputting and the storing of data by the client in a database;
proposing the addition of a bank payment card in the graphical interface, the validation of a bank payment card being performed by a transaction proposed to the client and performed via exchanges between the client management module and the transaction authorization server;
a transaction management module suitable
for proposing, to any terminal, used for the authentication of the client, an appropriate graphical interface for the display, the modification, and the pre-authorization of the transaction proposed to the client;
for communicating with the transaction authorization server, via the sending of an authorization request for the transaction pre-authorized by the client.

10. The system according to claim 9, further comprising
an exclusive card authentication server interfaced with the client management module and the transaction management module, suitable for receiving the identification of an exclusive card added by the client in the graphical interface of the client management module;
an exclusive card transaction authorization server suitable for receiving a transaction request from the transaction management module for an exclusive card and sending a response concerning the request to the transaction management module.
